(19) United States
(12) Patent Application Publication
(10) Pub. No.: US 2014/0356263 A1
(43) Pub. Date: Dec. 4, 2014

(54) METHOD FOR PRODUCING HIGH-PURITY SYNTHETIC MANETITE BY OXIDATION FROM METAL WASTE AND APPLIANCE FOR PRODUCING SAME

(71) Applicant: Gabriel Santiago JARAMILLO BOTERO, Sogamoso (CO)

(72) Inventor: Gabriel Santiago JARAMILLO BOTERO, Sogamoso (CO)

(21) Appl. No.: 14/191,230

(22) Filed: Feb. 26, 2014

(30) Foreign Application Priority Data
May 30, 2013 (WO) WO2013076539

(51) Int. Cl. C01G 49/08

(52) U.S. Cl. CPC C01G 49/08
USPC 423/152; 423/632

(57) ABSTRACT

The invention relates to a method for producing magnetite with a purity of no less than 90% and higher than 98%, by oxidation of pulverized wustita (iron oxide), at temperatures ranging from 200° C. to 800° C., with the addition of water in liquid or steam form, in counter-current or concurrently, in an externally heated reaction chamber with a controlled atmosphere. The amount of water used to oxidize the wustita being 60 to 500 ml per kilogram of wustita, the grains of wustita powder injected into the reaction chamber having a size no greater than 100 μm for optimal reaction.

### CROSS REFERENCE TO RELATED APPLICATION

This application claims priority to CO20110109516 filed on Aug. 26, 2011 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention consists in a method for converting the wustita (iron oxide) in high purity synthetic magnetite. Specifically the invention describes a process of oxidation of wustita in a reactor under high temperature and controlled atmosphere with a flow of water or water vapor flow, counter flow or concurrently flow, for a set time to allow reaction for total conversion from wustita to magnetite. The invention contemplates the design of a reactor which when heated, forms the result of this invention. The reaction is described in the following equation:

3FeO₍ₛ₎+H₂O_{(g)}→Fe₃O₄_{₍ₛ₎}+H₂_{_{(g)}}

The present invention is a process to produce synthetic magnetite of high purity from wustita. In particular, the invention refers to a process of oxidation of the wustita powder with superheated water vapor into magnetite of high purity, where the wustita is oxidized in a reactor with a flow of steam in countercurrent or concurrent, over a period of time and at a temperature which may allow total oxidation of the wustita in magnetite.

2. Description of Related Art Including Information Disclosed Under 37 CFR 1.97 and 1.98

### DESCRIPTION OF THE TECHNOLOGY

Ancestrally magnetite was obtained from natural deposits and extraction involves methods and machines that don't have a significant impact on the environment. The method is costly due to the hardness of rock mineral magnetite.

For several years it is known how to convert the compound hematite Fe₂O₃ into magnetite Fe₃O₄. Hematite is an iron ore reddish brown by-product of the regeneration of hydrochloric acid used in pickling or cleaning of steel wires in processes such as electroplating. The byproduct has been traditionally obtained from iron chloride that is widely used in industry. Synthetic magnetite is obtained by reduction from this process and is used for their magnetic properties, or as a pigment.

It is known that the conversion of hematite to magnetite occurs in the presence of a reducing agent such as hydrogen, carbon monoxide, methane gas or a liquid such as oil. The presence of carbon monoxide, liquid petroleum gas, methane gas or natural gas, acts as a reducing agent allowing the reduction of hematite to magnetite. U.S. Pat. Nos. 5,348,160 and 5,749,791 describe this conversion.

It has also been known to reduce the hematite Fe₂O₃ of an inorganic powder non-ferrous, with temperatures of about 200 to 700° C. in the presence of a reducing gas, to suspend midway reduction to produce a partially reduced powder, and then oxidizing the surface of the dust that has been known to reduce the hematite Fe₂O₃ of an inorganic powder non-ferrous, with temperatures of about 200 to 700° C. in the presence of a reducing gas, to suspend midway reduction to produce a partially reduced powder, and then oxidizing the surface of the dust with oxygen-containing gas to produce a composite partially reduced powder comprising magnetite and iron. The reducing gas may be hydrogen, carbon monoxide, methane or ethane as disclosed in U.S. Pat. No. 6,827,757. The purity of the process is approximately 83%.

The known processes for producing magnetite from hematite are expensive because they require several steps and are difficult to obtain magnetite.

In the metallurgical industry a lot of metallic waste (called mill scale), from 2% to 3% for each heating, as a result of oxidation caused by the high temperatures, generally exceeding occurs at 800° C. They not have a profitable industrial application. This creates an obvious environmental impact and cost of disposal. In the blast furnace steelmakers can use this mill scale on clinker or adding it to the furnace charge because this process involves CO₂ reduction. However the cost of transportation makes it a very expensive raw material for recycling mil scales as found in other industries such as the producers of steel bars, steel sheets or electric furnaces and continuous casting. These metallic wastes are characterized by having an approximate composition of 70% wüstita, 25% magnetite, and 5% of hematite. The composition may vary depending on factors such as alloy composition under high temperature, heating time, applied temperature, or heat shock treatment, etc.

The mill scale is usually stacked or placed in large pits with other scrap metal, non-metal, or electric furnace slag. This requires the adaptation of land for this purpose but does not prevent the permanent and indefinite accumulation of this waste because there is no until the moment an appropriate method of recycling. In Colombia 80,000 tons of steel are produced monthly in the three main steel, which leads to an output of 1600-2400 tons per month of scale that accumulate can turn into a real environmental problem.

### STATE OF THE TECHNOLOGY

There are several processes known to magnetite, Fe₃O₄, Fe₂O₃, Hematite from obtaining. The conversion of the Hematite magnetite is done by a chemical reduction. The reducing agents commonly used for this process are gas hydrogen, monoxide from carbon, gas methane, propane, gas ethane, etc.

Is known about the production of Hematite spray of ferric chloride to produce Hematite granular and its subsequent reduction to temperatures of about 900° C. to 1000° C. The reduction is done with the use of hydrogen and carbon monoxide to upstream of the granules of Hematite from a flame from a burner. Reducing conditions are maintained throughout the reactor with the injection of additional gas near the discharge zone. See for example U.S. Pat. No. 4,436,681 where neither the purity grades achieved nor the operating conditions are not mentioned.

The reduction of Hematite is also noted by a reducing gas in the presence of a non-ferrous inorganic compound powder at temperatures close to 200° C. and 700° C. stopping the reduction around the middle of the stream to produce a partially reduced powder, and superficially to oxidize partially reduced powder with a gas containing oxygen to produce a powder composed of magnetite and iron. The reducer gas can be hydrogen, carbon monoxide, methane or ethane. See, U.S. Pat. No. 6,827,757. Purity obtained in this process is 83%.

The reduction of Hematite by organic liquids or low-temperature aqueous mixtures (sludge) is also known. See U.S. Pat. Nos. 6,302,952, 5,512,195, 4,376,714 and 3,928,709.

We also know of the ancient art of reducing Hematite with other substances, such as waste oil, alcohols and steam, usually at temperatures below 700° C. See, e.g., U.S. Pat. Nos. 4,311,684, 2,693,409 and 672,192.

The process for producing magnetite latest known is the reduction of hematite obtained as a byproduct of the regeneration of hydrochloric acid used to cleanse the steel before galvanizing processing, among others. The magnetite obtained is up to 98% purity. The reactor used in this process has an inclination of up to 5% to facilitate advancement of the load of hematite to the exit. The production rate of the reactor used in this process is given by the inclination thereof (up to 5%), the rotation speed and the temperatures used. See U.S. Pat. No. 7,744,848.

The techniques used in the above processes are aimed at the reduction of hematite by reducing agents, gases generally, apart from expensive, involve risk of environmental contamination. The yields, in terms of the magnetite conversion factor, are in the order of 80% except for the case of the method described in U.S. Pat. No. 7,744,848 with up to 98% purity of the magnetite.

Furthermore, the use of metallurgy or mining waste has been extensively investigated for the production of FeO or metallic iron to be recycled in the steelmaking processes. Again this is a chemical reduction in which magnetite, Fe₃O₄ and hematite, Fe₂O₃ are reduced to obtain FeO and metallic iron.

(Adriano Ferreira da Cunha, Metallurgy & Materials, Caracterizacao, beneficiemento and reciclagem of steel process carepas geradas em 2006, 111-116, jan-mar).

(Adriana Esguerra et al; Assessment of reducibility of mill scale from a steel plant from the region, by reduction with carbon monoxide. Revista de Metalurgia & Materiales, 2009 S1 (3): 7289-7294).

### BRIEF SUMMARY OF THE INVENTION

The object of the process to oxidize the wustita (iron oxide) injection of water vapor in a horizontal reactor (1) heated externally (3), concurrent or countercurrent and through this process, obtaining synthetic magnetite.

The object of the invention is to provide a process and a product that includes a vapor-solid relationship and a ratio of wustita within the reactor power, providing simple instructions for obtaining high purity magnetite.

Similarly it is object of this invention to provide a process and a product that include a maximum range of 200° C. to 800° C., preferably between 350° C. and 700° C., to provide an optimal level of performance.

It is another object of the process to contain at least 97% pure magnetite, and also meet a magnetic saturation of more than 85.0 emu/g.

It is also the object of this process to provide an industrial process that can be performed on a large scale and with very low production costs.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a schematized reactor design.

FIG. 2 is a front view of the load side.

FIG. 3 is a front view of the discharge side.

FIG. 4 is a schematic drawing of the pendular seal system of the reactor by the end of input.

FIG. 5 is a schematic drawing of the pendular seal system of the reactor by the end of the exit.

FIG. 6 is a diagram of the process of the invention, where the wustita and the water vapor or water go upstream or in the opposite direction.

FIG. 7 is a schematic drawing of the invention process, where the wustita and the water vapor or water goes in the same direction or concurrent.

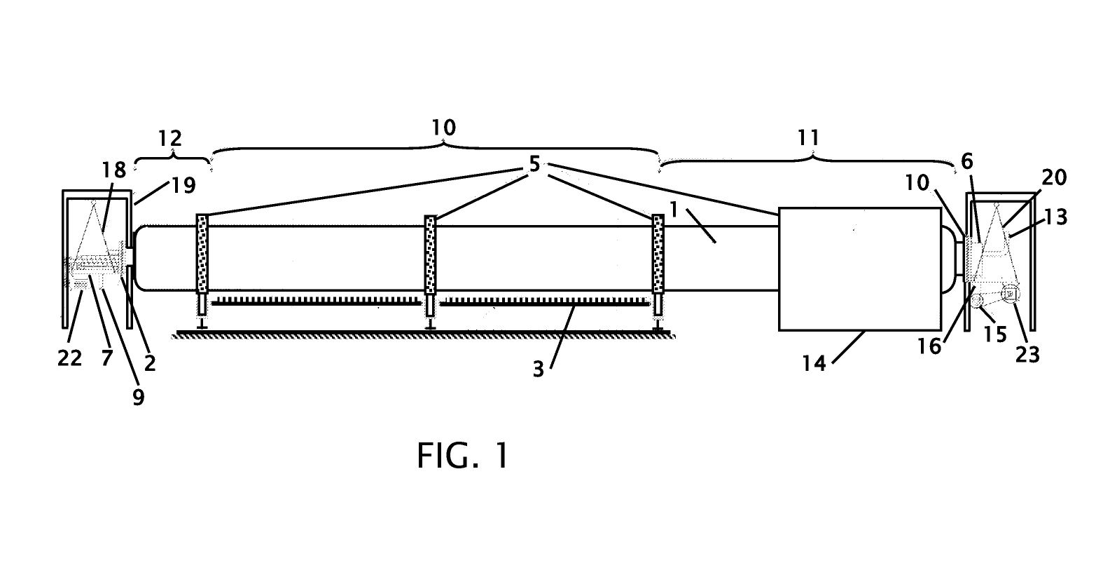

### INDICATIONS IN THE FIGURES

1. Body of the reactor.
2. Ceramic airtight lid seal of entrance to the reactor, designed to prevent the uncontrolled outflow of gases, steam and dust environment.
3. System of heating of the reactor and gas burners.
4. Top entry.
5. Bearing tracks attached to the reactor.
6. Exit cover.
7. Screw the reactor power.
8. Zone heating and thermochemical reaction.
9. Output to the trap of dust and water vapor.
10. Tight seal from the top of the output of the reactor, designed to prevent the uncontrolled outflow of gases, steam and dust environment.
11. Cooling of the reactor area.
12. Cargo area of raw material.
13. Input of water or steam.
14. Refractory.
15. Screw output.
16. Trap of finished product output.
17. Reactor support wheels.
18. The pendulum of power cords.
19. Structure to support the pendulum of power.
20. The pendulum output strings.
21. Structure for pendulum output support.
22. The feeding screw drive motor.
23. The output screw drive motor.
24. Input of the reactor cover.

### DETAILED DESCRIPTION OF THE INVENTION

The present process is for producing high purity synthetic where the process produces magnetite of high purity from wustita. In particular, the process uses oxidation of wustita powder with superheated water vapor is converted into magnetite of high purity, where the wustita is oxidized in a reactor by a flow of water or water vapor, in countercurrent or concurrent, over a period of time and at a temperature which allow total oxidation of the wustita in magnetite.

The processes involved in the present invention described below.

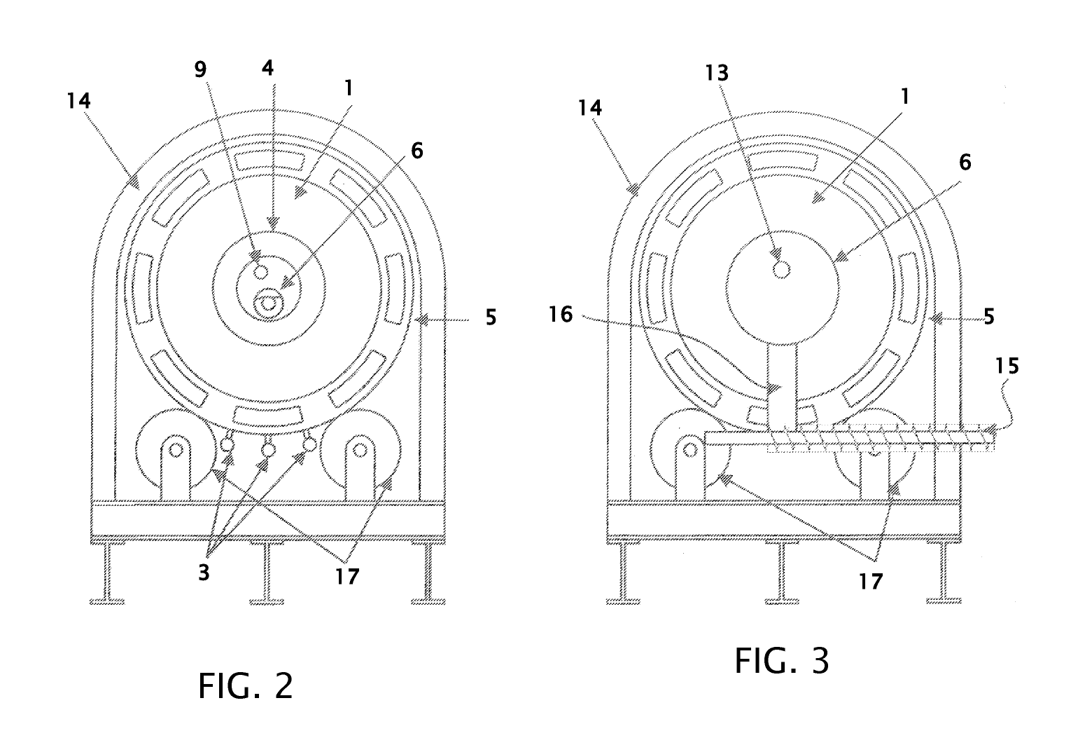

The reactor designed for the process to consist of four main stages such as: A pendular system power and closing (FIG. 2); A cylindrical reactor (1) slim body with a length-diameter of 10 to 0.8 ratio; A pendular system of discharge and closing (FIG. 3); A steam (13) water supply system; A trap of steam, gases of reaction and powders (9); An external heating system for the reaction of the wustita (3).

The term “wustita” refers to one of the forms from the oxidation of iron, the wustita, and which is the largest constituent (65 to 75%) of the husk, generated in the different processes of production of steel and iron.

The “husk” refers to the washer or husk which is formed on the surface of the steel or iron after being exposed to temperatures high, usually higher than 800° C., and follows naturally or by mechanical processes and represents a decline of 2% to 3% by weight of the original product. The generation of husk is inherent in the production of steel and is measured for metal yield in a metallurgical processes. This means that for every 100 kg of steel heated above 1000° C. are obtained at least 2 kg of quinine and 98 kg of steel.

The term ‘steam’ refers to water vapor if not stated otherwise.

The water used in this process can be applied in any form but most indicated are liquid or steam. H₂O₂ hydrogen peroxide can be used for this process, but their high cost is not viable for an industrial process.

Unlike all known processes where the thermochemical reaction is a reduction of the raw material, the process is oxidation, and therefore any ingredient can be used or reactive oxidant. The oxidation reaction can occur in nature, but it is a long process, several months or years. Temperature is used to increase the speed of oxidation in the presence of an oxidizing agent.

The only reactor has a unique area of warming (zone 10) making it easy to control the temperature and magnetite as well as performance quality. This is because, in the right conditions of temperature and the amount of steam added to the reactor, long enough to accomplish the oxidation reaction required for the conversion of wustita into magnetite. On the other hand the process prevents magnetite present in the raw material to transform in an uncontrolled way in another type of oxide of iron, i.e., Hematite or wustita.

The reactor (1) is a quite horizontal slender cylinder where one end serves as a feeding of matter prima (area 12) and the other as starting area and cooling of finished product (area 11). The reactor (1) has 4 tracks (5) of larger diameter that move on a set of 4 pairs of wheels of support (17). The rotary motion is provided by a motor (not shown). The entrance of steam or water (13) and the output of gases (9) can change location depending on if the gases (9) opt by the injection of these concurrently or backwashing. Depending on the case, the other end serves as outgassing and this settles the dust and steam trap (not shown). The inlet diameter is smaller than the diameter of the outlet. This allows material to advance smoothly by the reactor in one direction only and drip overflow at the opposite end. The advantage of this system is that the ratio of production of the reactor is given only by food ratio with a screw (15), which facilitates the controlled exposure of raw material to the oxidizing environment induced by the temperature and the steam, that is, the reaction time. The speed of rotation of the reactor does not affect the rate of production but facilitates exposure of dust to the oxidizing medium. In the Interior of the reactor walls there are a series of baffles that keep the material in permanent agitation, and exposure to the oxidizing medium.

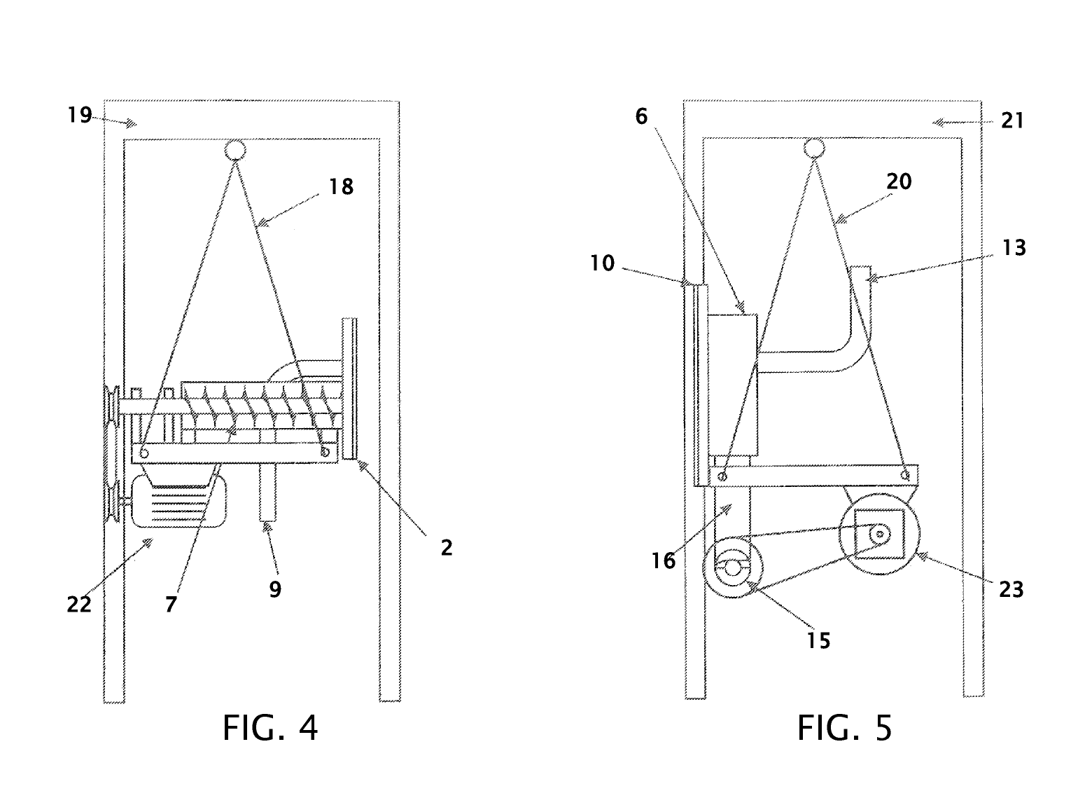

The power of the reactor system consists of a pendulum set (FIG. 4) hanging from a support (19), facing the mouth of the reactor by means of a ceramic seal (2). This configuration ensures a tight fit between the reactor and the pendulum assembly (FIG. 4) to prevent the exit of gases, steam and dust in uncontrolled way of the reactor. The set consists of a set of strings (18), a lid with ceramic seal (2), a screw conveyor (7), gases, steam and dust (9) output vent and a (22) motor which transmits movement to the screw (7).

The set feed of the reactor system consists of a pendular set (FIG. 5), similar to the power supply, hung from a bracket (21). It is composed of a set of strings (20), a cover (6) with ceramic seal (10) airtight, a pipeline (13) for the entry of water vapor, a screw conveyor (15), a gorge (16) that serves as a trap to prevent the exit of gases, dust and steam for this area and a (23) motor which transmits movement to the screw (15).

Tilting systems of input and output are designed to stay relatively still while the reactor spins. The pendular system allows that the sets of input and output of the reactor to permanently adhere to irregularities due to manufacturing defects and the dilatations caused by global warming. This system uses ceramic seals (2-10) at both ends to maintain a convenient adjustment. These seals are chosen to withstand high temperatures and wear by friction.

The reactor is isolated in its entire length by a roof covered with refractory ceramic blanket (14) or refractory cement or brick.

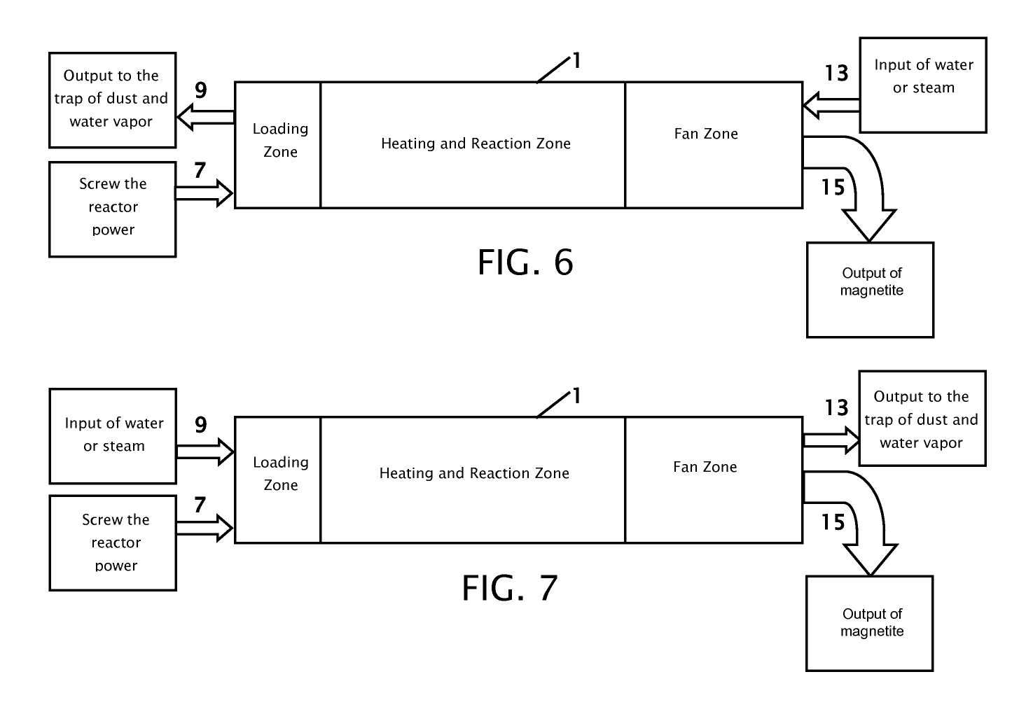

FIG. 6 is a diagram of the process of the invention, where the wustita and the water vapor or water go upstream or in the opposite direction and FIG. 7 is a schematic drawing of the invention process, where the wustita and the water vapor or water goes in the same direction or concurrent.

Thus, specific embodiments of a process for producing high purity synthetic have been disclosed. It should be apparent, however, to those skilled in the art that many more modifications besides those described are possible without departing from the inventive concepts herein. The inventive subject matter, therefore, is not to be restricted except in the spirit of the appended claims.

1. A process for producing high purity synthetic comprising:
feeding wustita into one end of a reactor by means of a screw feeder attached to a pendulum device that prevents steam output and dust pollution to the atmosphere;
a water supply system or steam concurrently or counter currently as thermochemical transformation region;
a heating system with external heating which can raise the temperature of the reagents up to a range between 200° C. and 800° C. which accelerates the conversion of magnetite to wustita in high purity synthetic;
an evacuation system magnetite by a metering auger attached to a pendulum device that prevents or trap steam output and dust pollutants into the atmosphere, and
cooling and collection of synthetic magnetite where it has at least 95% of purity and can reach more than 98%.

2. The process for producing high purity synthetic according to claim 1 wherein the process for producing synthetic magnetite characterized by the use of scrap steel industry, called mill scale generated during heating of the steel or iron at temperatures above 800° C.

3. The process for producing high purity synthetic according to claim 1 includes the use of temperatures in the range of 200° C. to 800° C., preferably 500° C.

4. The process for producing high purity synthetic according to claim 1 wherein the heating or burner device has a length of about 60% of the length of the reactor to the discharge outlet of the reactor.

5. The process for producing high purity synthetic according to claim 1 wherein the steam supplied to the reaction is between 57 g and 570 g per kilogram of wüstita introduced to the reactor.

6. The process for producing high purity synthetic according to claim 1 wherein the steam feed and feeding mil scale are simultaneous and enter the reactor at opposite ends and travel through the reactor in opposite directions, so that the water vapor ranges from the outlet to the inlet side and mil scale from the inlet side to the output side.

7. The process for producing high purity synthetic according to claim 1 wherein the raw material derived from the oxide layer, crystal-like, consisting of 73% to 23% wustita and magnetite respectively, which is formed at high temperature on the surface of steel and falls naturally in cooling or process of stacking, laminating, rolling, wire drawing, forging, etc. or mechanically forced manner.

8. The process for producing high purity synthetic according to claim 7, wherein the metallurgical mill scale waste comes where there is a material that is considered as industrial waste.

9. The process for producing high purity synthetic according to claim 8 wherein the mill scale comes from the process of wire drawing of steel wire, scale from iron cold rolling or hot rolling.

10. The process for producing high purity synthetic according to claim 9, wherein the wustita is from mill scale process rolling of reinforcing steel.
